(19) United States
(12) Patent Application Publication
(10) Pub. No.: US 2007/0228753 A1
(43) Pub. Date: Oct. 4, 2007

(54) Remotely operated elevator and method

(76) Inventors: Robert Dugal, Houston, TX (US); Lawrence E. Childress II, Lafayette, LA (US)

Correspondence Address: PERRET DOISE;A PROFESSIONAL LAW CORPORATION, P.O. DRAWER 3408, LAFAYETTE, LA, 70502-3408, US

(21) Appl. No.: 11/393,288

(22) Filed: Mar. 30, 2006

(51) Int. Cl. B66C 1/62

(52) U.S. Cl. 294/88

(57) ABSTRACT

An elevator apparatus and method. The apparatus includes a circular member comprising a first and second semi-circular half and a hinge pin(s) for pivoting the first and second semi-circular half together. The elevator apparatus further includes a hinge rotary actuator(s) for activating the hinge pin(s) so that the first and second semi-circular half pivot to form the circular member, a latch rotary actuator for latching the first semi-circular half and the second semi-circular half. In one preferred embodiment, the hinge rotary actuator(s) comprises: a first cylinder; a first rack disposed within the cylinder, the first rack being responsive to a pressure within the cylinder; and a first roller having teeth disposed thereon, wherein the first rack and the teeth are engaged and wherein the roller is connected to the hinge pin.

### BACKGROUND OF THE INVENTION

This invention relates to an apparatus for handling tubulars. More specifically, but not by way of limitation, this invention relates to an elevator apparatus and method for lifting tubular members on a rig.

Most oilfield tubular connections have a larger outer diameter than the tubular body. This difference in diameter creates a shoulder that can be utilized for lifting the tubular. To lift up the tubular, a tool called an elevator wraps around the tubular body. Upon hoisting the elevator having been wrapped around the tubular, the upper section of the elevator makes contact with the corresponding shoulder of the connection. The contact area between the elevator and shoulder creates an interference providing a lifting surface for the tubular.

Elevators are comprised of a body, one or more hinged doors and a latch. To close the elevator around the tubular, it is lowered adjacent to the tubular (usually suspended from the traveling block) and the two portions are hingedly closed around the tubular below the connection. The latch closes after the portions come together and locks it shut.

Automation of tubular handling devices is a useful technique to incorporate safety and efficiency in the handling of tubular members. Prior art devices have attempted to automate the handling of tubular members with elevators. However, these prior art devices suffer from several deficiencies such as reliability, cost of manufacture, repair, maintenance, simplicity of operation, etc.

Most existing remote operated elevators are comprised of an elevator of conventional design, utilizing hydraulic or pneumatic cylinders, attached to the elevator, to offer the feature of remote operation. These mounted cylinders create operational and ergonomic issues that must be addressed to assure proper functionality.

Therefore, an object of the present invention is to provide an apparatus and method for handling a tubular member. Another object is to provide an elevator apparatus and method that can be activated remotely. Yet another object is an elevator apparatus that can be remotely opened or closed. Still yet another object is an elevator apparatus and method that can latch or unlatch remotely. These objects and many other objects will become apparent from a reading of the present disclosure.

### SUMMARY OF THE INVENTION

An elevator apparatus is disclosed. The apparatus includes a circular member comprising a first and a second portion and a hinge pin means operatively associated with the first portion and the second portion, for pivoting the first portion relative to the second portion. The elevator apparatus further includes a first rotary actuator for activating the hinge pin so that the first and second portion pivot to form a circular member, a latch mechanism for latching the first portion and the second portion, and a second rotary actuator for actuating the latch mechanism.

In one preferred embodiment, the first rotary actuator comprises: a first cylinder; a first rack disposed within the cylinder, the first rack being responsive to a pressure within the cylinder; and a first roller having teeth disposed thereon, wherein the first rack and the teeth are engaged and wherein the first roller is connected to the hinge pin means.

The first cylinder, in the most preferred embodiment, is a hydraulic or pneumatic pressure cylinder receiving pressure from a source such as a hydraulic or pneumatic control unit. Also, in the most preferred embodiment, the second rotary actuator comprises: a second cylinder; a second rack disposed within the second cylinder, with the second rack being responsive to a pressure within the second cylinder; and a second roller having teeth disposed thereon, wherein the second rack and teeth are engaged and wherein the second roller is connected to a first pin so that lateral movement of the second rack causes extension of the first pin.

The second roller, in one preferred embodiment, is connected to a second pin offset from the first pin and wherein lateral movement of the second rack causes extension of the second pin in a direction opposite from the first pin.

The apparatus may further comprise an indicator means for detecting the extension of the first pin. In one preferred embodiment, the indicator means comprises a relay switch that is controlled by the position of the first pin.

In another preferred embodiment, the first pin has a first position that is recessed within an aperture within a housing and a second position that extends from the housing, and wherein the indicator means comprises a projection that is positioned within the aperture and a relay switch operatively connected to the projection, and wherein upon movement of the first pin from the recessed position to the extended position, the projection is lifted from the aperture which trips a relay switch.

A method of lifting a tubular member on a drilling rig is also disclosed. The method comprises suspending an elevator apparatus from the rig. The elevator apparatus includes: a first portion and a second portion; a hinge pin member operatively associated with the first portion and the second portions, for pivoting the first portion relative to the second portion; a hinge rotary actuator for moving the hinge pin; and, a latch member for latching the first portion and the second portion in order to form a circular member about the tubular.

The method further comprises surrounding the elevator apparatus about the tubular member, with the tubular member being suspended in a rotary table on the rig with a slip device or in a more horizontal position from the v-door, pipe rack or catwalk, and activating the hinge rotary actuator so that the first portion and the second portion pivots about the hinge pin. The method further includes latching the first portion and the second portion—together thereby forming the circular member, releasing the tubular member from the slip device, and lifting the tubular with the elevator apparatus. In one preferred embodiment, the method also includes detecting whether the first portion and the second portion are latched.

The method may further comprise suspending the tubular member within the rotary table on the rig, and unlatching the first portion from the second portion by activating a latch rotary actuator operatively associated with the latch member. Next, the hinge pin is activated via the first hinge rotary actuator, and the first portion and the second portion is pivoted in order to separate and open up the two portion.

In one preferred embodiment, the hinge rotary actuator comprises: a pressure cylinder; a rack disposed within said cylinder and responsive to a pressure; a roller having teeth thereon, with the teeth engaging the rack. In this embodiment, the step of activating the hinge rotary actuator comprises: selectively applying a pressure in the cylinder; moving the rack in response to the pressure; rotating the roller; and pivoting the hinge pin thereby separating the first portion from the second portion.

The second rotary actuator, in one preferred embodiment, comprises: a pressure cylinder; a rack disposed within the cylinder and responsive to a pressure; a roller having teeth thereon, with the teeth engaging the rack; and wherein the step of activating the door rotary actuator(s) comprises: selectively applying a pressure to the cylinder; moving the rack in response to the pressure; and rotating the roller so that the latching pin contracts so that the first and the second portion are no longer latched together.

An advantage of the present invention includes the device that can be remotely controlled. Another advantage is that the door mechanism and latch mechanism is dependable and can be activated numerous times. Yet another advantage is that the device provides a safety means to determine if the device is latched.

Another advantage is that the design incorporates rotary actuator(s) solidly affixed to the hinge boss area/areas, which is directly attached to the hinge pin/pins. Yet another advantage is that the design reduces the size and complexity of conventionally designed units. By minimizing the fabricated attachment areas and hydraulic/pneumatic cylinders, it also reduces the risk of failure in the attachment and linkage areas.

A feature of the elevator apparatus includes a rotary actuated hinge. Another is the use of a rotary actuated latch. Still yet another feature is the rotary actuator uses rack and pinion, and wherein the movement of the rack is initiated via a pressure.

### BRIEF DESCRIPTION OF THE DRAWINGS

FIG. 1 is a perspective view of the elevator apparatus of the present invention.

FIG. 2 is the elevator apparatus shown in FIG. 1 wherein the elevator apparatus has been pivoted to the open position.

FIG. 3 is a perspective view of the elevator apparatus seen in FIG. 1 depicting a partial cut-away illustration of the rotary actuator for the hinge means.

FIG. 4 is a perspective view of the rotary actuator for the hinge means seen in FIG. 3.

FIG. 5 is a perspective view of the opened elevator apparatus and the latch means in the unlatched position.

FIG. 6 is a perspective view of the rotary actuator for the latch means seen in FIG. 5.

FIG. 7 is a partial perspective view of the closed elevator apparatus depicting a cut-away illustration of the latch means.

FIG. 8 is a sequential view of the closed elevator apparatus seen in FIG. 7 depicting the closed latch means.

FIG. 9 is a schematic illustrating a drilling rig, with an elevator apparatus suspended from the drilling rig derrick.

### DETAILED DESCRIPTION OF THE PREFERRED EMBODIMENTS

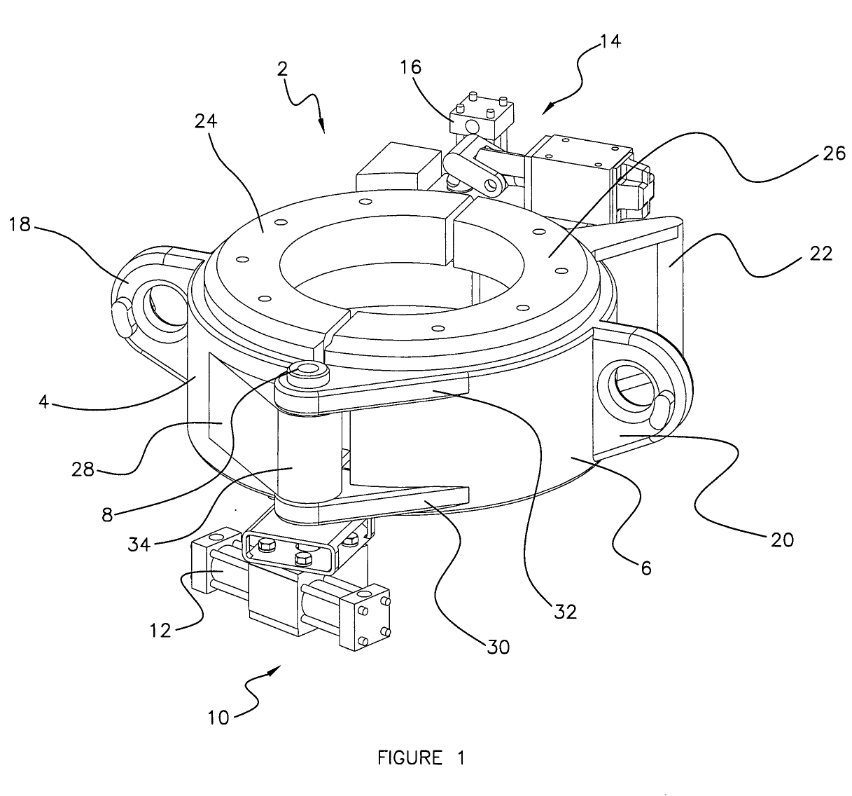

Referring now to FIG. 1, a perspective view of the elevator apparatus 2 (sometimes referred to as the apparatus 2) of the present invention will now be described. In the most preferred embodiment, the apparatus 2 has a first semi-circular half 4 (also referred to as the first portion 4) and a second semi-circular half 6 (also referred to as second portion 6), and wherein the first semi-circular half 4 and the second semi-circular half 6 are hinged together via hinge pin 8. The hinge pin 8 will be turned by the hinge rotary actuator 10 (sometimes referred to as the first rotary actuator 10). The hinge rotary actuator 10 includes an internal rack and pinion that are housed within a pressure cylinder 12 that will be described later. The rotary actuator is commercially available from Parker Hannifin Corp. under the name Parker Rotary Actuator.

FIG. 1 further shows the latch rotary actuator 14 (sometimes referred to as the second rotary actuator 14). The latch rotary actuator 14 includes an internal rack and pinions that are housed within a pressure cylinder 16 that will be described later. As noted earlier, rotary actuators are commercially available. FIG. 1 further depict the eyelets 18, 20 for attaching a cable to the apparatus 2 in order to suspend the apparatus 2 from a derrick of a drilling rig, as readily understood by those of ordinary skill in the art.

A handle 22 is attached so that a roughneck can aid in opening, closing and/or handling the apparatus 2. The internal portion of the apparatus 2 is configured to receive a tubular member, such as a drill pipe. FIG. 1 depicts that each of the semi-circular halves 4, 6 have an inner concave surface which in turn extends to the top radial surface 24, 26, respectfully, and wherein the lower section of the connection will rest on the radial surfaces 24, 26 as understood by those of ordinary skill in the art. FIG. 1 further shows the wedge member 28, which is attached to the first portion, as well the brackets 30, 32 of the hinge boss, which are attached to the second portion 6. The wedge member 28 contains a cylindrical end portion 34, and the brackets 30, 32 contain apertures. As shown in FIG. 1, the hinge pin 8 is configured to be inserted into the cylindrical end portion 34, and bracket apertures. The control unit 36 for delivering a hydraulic fluid or pneumatic pressure to the hinge rotary actuator 10 and the latch rotary actuator is depicted. The hydraulic control unit 36 is commercially available. The control unit 36 is remotely controlled by an operator.

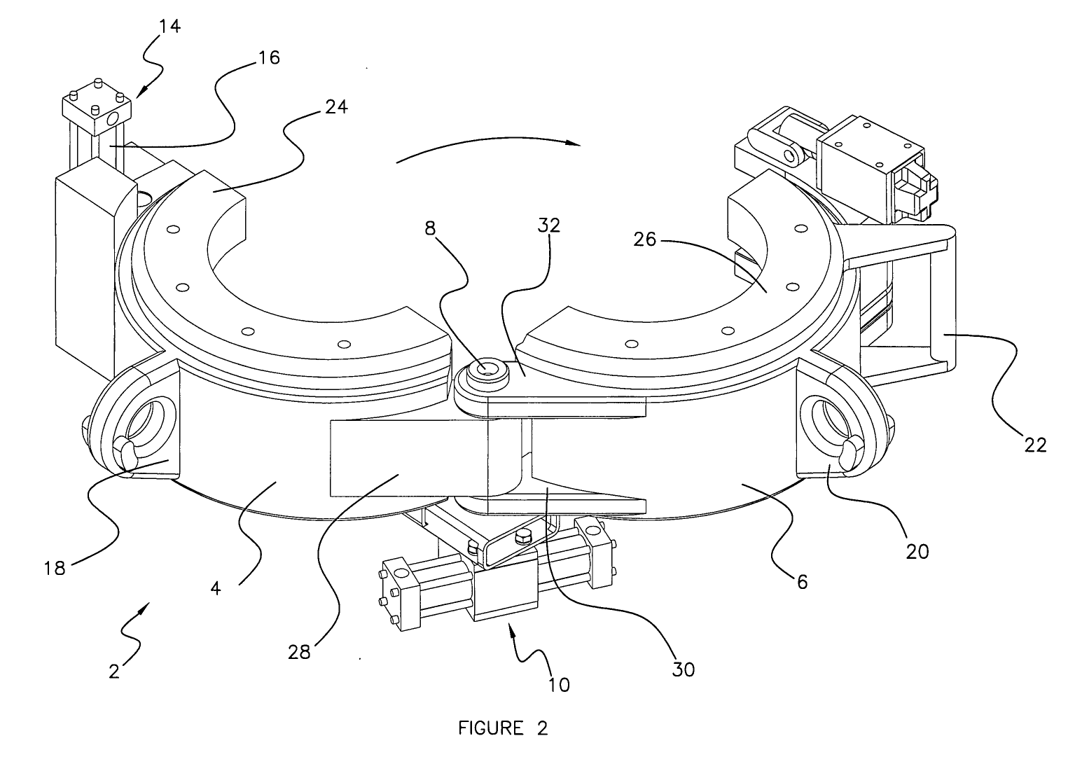

Referring now to FIG. 2, the elevator apparatus 2 is shown in FIG. 1, wherein the apparatus 2 has been pivoted to the open position. It should be noted that like numbers appearing in the various figures refer to like components. Hence, the operator would have activated the latch rotary actuator 14 so that the apparatus 2 is unlatched. Additionally, the hinge rotary actuator 10 has also been activated so that the hinge pin 8 has rotated thereby separating the first semi-circular half 4 from the second semi-circular half 6. In this way, a tubular can be inserted into the apparatus 2, or the tubular can be taken-out of the apparatus 2.

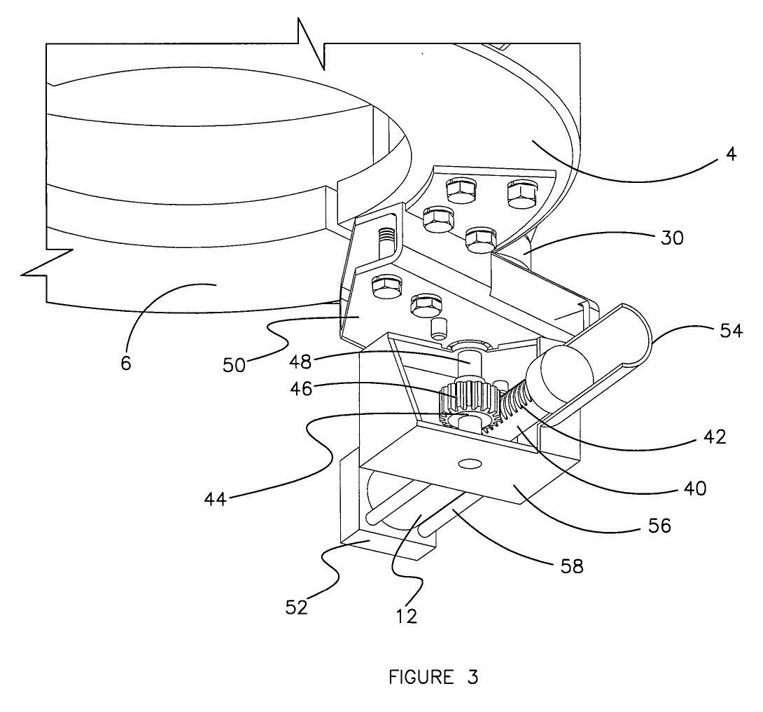

FIG. 3 is a perspective view of the apparatus 2 seen in FIG. 1 depicting a partial cut-away illustration of the hinge rotary actuator 10 for the hinge means 8. More specifically, the hinge rotary actuator 10 comprises the pressure cylinder 12 and the rack 40, wherein the rack contains the teeth 42, and the roller 44. As seen in FIG. 3, the roller 44 contains teeth 46 that will engage with teeth 42. The roller 44 has the stem 48 which is connected to the hinge pin 8. The brace means 50 connects the hinge rotary actuator 10 to the apparatus 2, and in particular to the first semi-circular half 4 and to the hinge pin(s)

The hinge rotary actuator further has a first end 52 connected to the cylinder 12 and a second end 54 connected to the cylinder 12, wherein end 52 can allow a hydraulic fluid in and the end 54 can allow hydraulic fluid out . . . thereby providing for the later movement of the rack 40. The hydraulic fluid (or pneumatic pressure) is controlled from the control unit 36 as seen in FIG. 1. As the rack 40 moves from one end to the other end, rotational movement is imparted to the roller 44 which in turn causes the hinge pin 8 to rotate. FIG. 3 further illustrates the housing 56 which sealingly encases the roller 44 and rack 40 as shown. The housing 56 forms part of the cylinder 12 so that the roller 44 and rack are sealingly encased. A plurality of protective bars 58 surround the cylinder 12. The bars 58 are tie rods and used to keep the cylinder/end caps together and is common in most cylinders. As per the teachings of this invention, the operator will control, via the selective application of hydraulic or pneumatic pressure, the opening and closing of the apparatus 2 with the control unit 36, such as seen in FIG. 1.

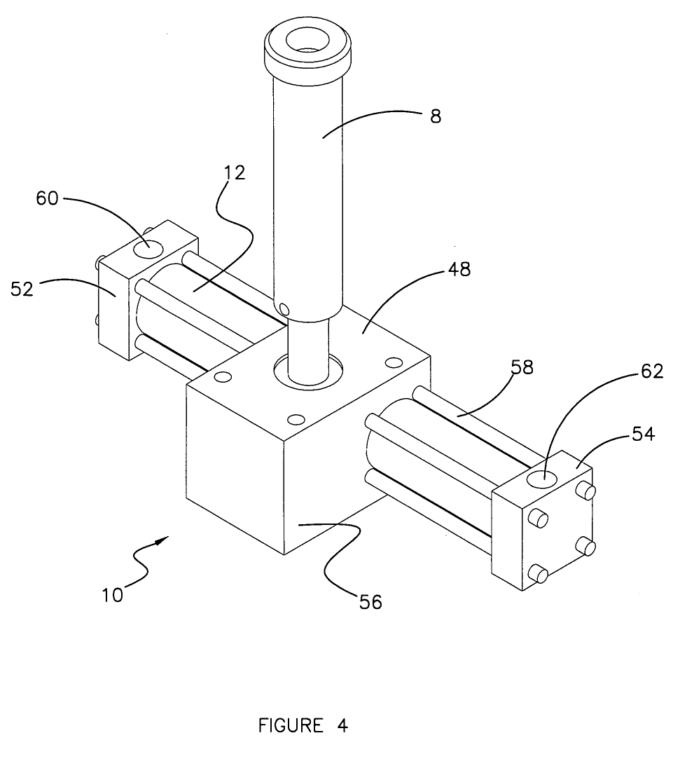

Referring now to FIG. 4, a perspective view of the hinge rotary actuator 10 for the hinge pin 8 will be described. The stem 48 is connected to the hinge pin 8. Hence, as the stem 48 is turned, the hinge pin 8 also turns. FIG. 4 also shows the opening 60 in the first end 52 and the opening 62 in the second end 54, wherein the openings 60, 62 allow for the input and output of the hydraulic fluid for supplying pressure to the rack 40 (not seen in this view) in order to move the rack laterally. As noted earlier, the lateral movement of the rack 40 causes the rotation of the stem 48.

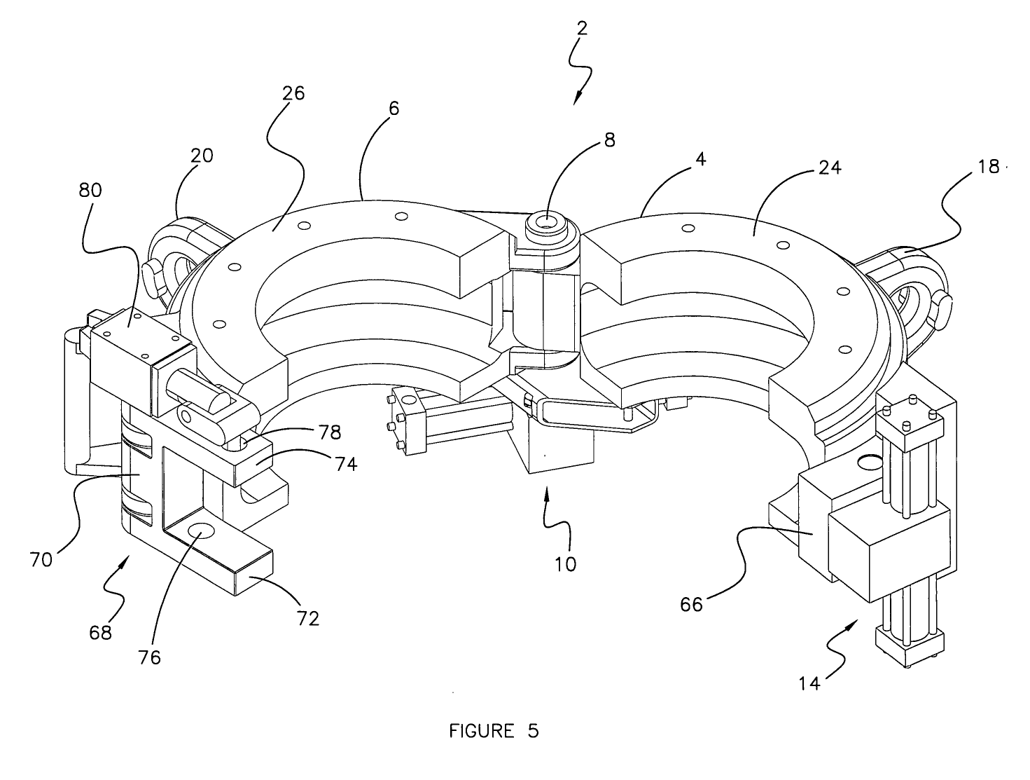

FIG. 5 is a perspective view of the opened elevator apparatus 2 and the latch means in the unlatched position. More specifically, FIG. 5 depicts the latch rotary actuator 14 that contains a rack and roller (not seen in this view). The latch rotary actuator 14 is commercially available from Parker Hannifin Corp. under the name Parker Rotary Actuators, as previously described. The latch means generally comprises a pin housing 66, that contains the pin means, and wherein the pin housing 66 is operatively attached with the latch rotary actuator 14, and wherein the latch rotary actuator 14 extends and contracts a set of pins (not seen in this view), as will be more fully described. The pin housing 66 is mounted to the first semi-circular half 4.

The pin housing 66 will cooperate and engage a receptacle member 68. The receptacle member 68 has a prong member 70 that contains a first prong 72 and a second prong 74. The first prong 72 has an aperture 76 and the second prong 74 has an aperture 78. The pins from the pin housing 66 will engage the apertures 76, 78, as will be more fully explained below. FIG. 5 further depicts the indicator means 80 for indicating whether the pin means have engaged the apertures 76, 78.

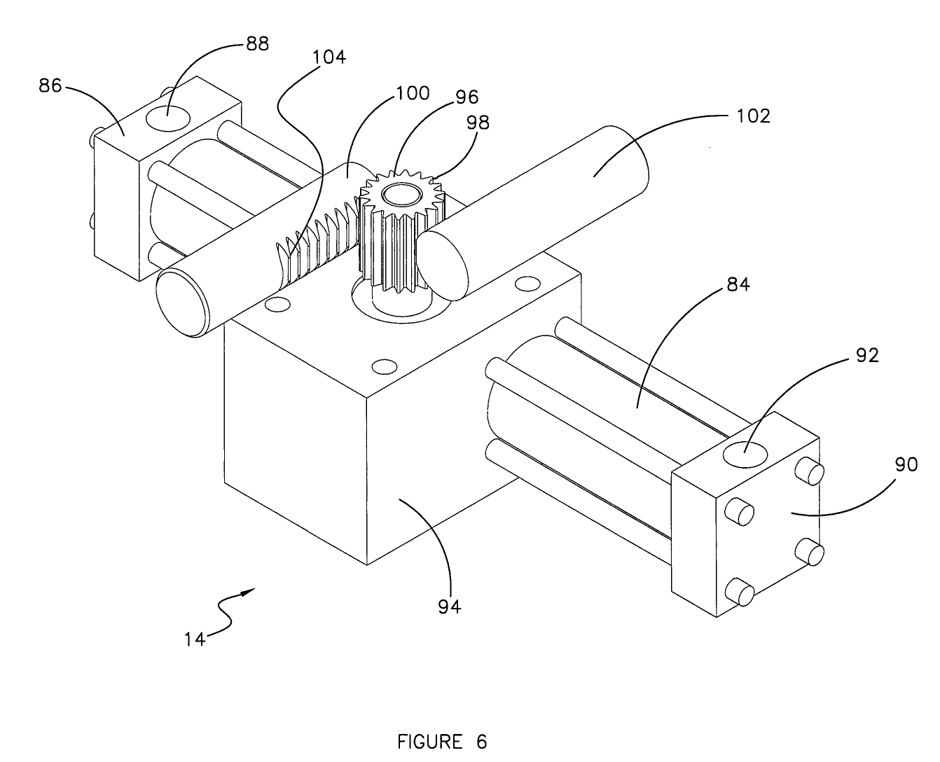

Referring now to FIG. 6, a perspective view of the latch rotary actuator 14 will now be described. The latch rotary actuator 14 has a pressure cylinder 84 that will contain the rack and pinion (not seen in this view). The latch rotary actuator 14 contains a first end 86 with the opening 88 and a second end 90 with the opening 92, and wherein the openings provide an inlet and outlet for the hydraulic pressure. The latch rotary actuator 14 further contains the housing 94, operatively associated with the cylinder 84, which sealingly houses the rack and pinion. Also, FIG. 6 depicts the roller 96 that contains the teeth 98. The roller 96 is operatively associated with the pinion as noted in the discussion of the hinge rotary actuator. A set of pins is included, namely the pin 100 and the pin 102, and wherein the pin 100 contains the teeth 104 and the pin 102 contains teeth (not seen in this view). The teeth on the pins 100, 102 will engage the teeth 98 so that movement of the roller 96 effects lateral movement of the pins 100, 102. The pins 100, 102 are offset relative to the roller 96, and when activated, the pins 100, 102 travel in opposite directions. In other words, pin 100 is on one side of roller 96 and pin 102 is on the other side of roller 96. In the extended position, the pins 100, 102 will engage the apertures in the prongs of the receptacle member 68 thereby latching the apparatus 2.

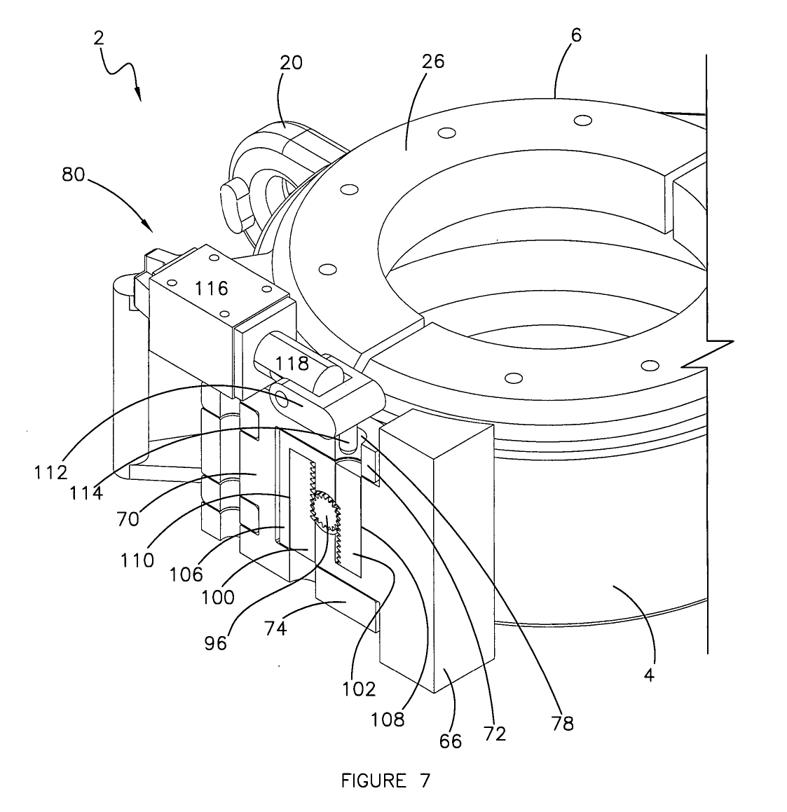

FIG. 7 is a partial perspective view of the closed elevator apparatus 2 depicting a cut-away illustration of the latch means. More specifically, the pins 100, 102 have been recessed within the pin housing 66 due to the linear actuation of the roller 96. In the view of FIG. 7, the elevator 2 is unlatched. FIG. 7 shows how the prongs 72, 74 are disposed about the housing extension 106, and wherein that extension 106 contains cavities 108, 110 for placement of the pins 100, 102.

The indicator means 80 is also shown. The indicator means 80 has a pivoting arm 112 that contains the projection 114. As seen in FIG. 7, the projection 114 is disposed through the aperture 78 since the pin 102 is recessed within the aperture 108. The pivoting arm 112 is connected to the relay switch housing 116 via member 118. In the position seen in FIG. 7, the relay switch is connected, and therefore, a light is activated and wherein the operator can tell that the latch is in the open position by the light. The relay switch is commercially available from Rexroth Bosch Group under the name Directional Valve.

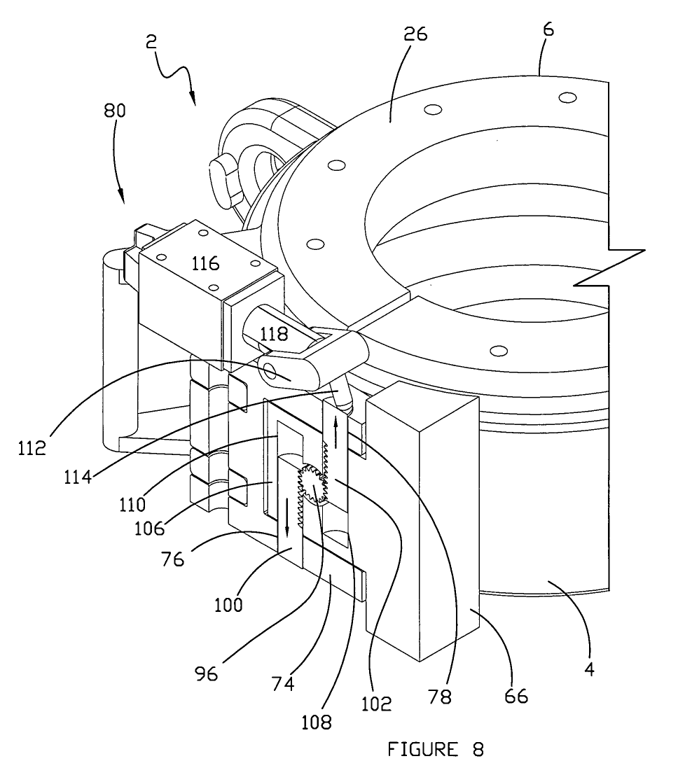

Referring now to FIG. 8, a sequential view of the closed elevator apparatus 2 seen in FIG. 7 depicting the closed latch means will now be described. In other words, the apparatus 2 is latched. More specifically, the rotation of the roller 96 has caused the pins 100, 102 to extend through the apertures 76, 78 of the receptacle member 68 thereby latching the apparatus 2. Additionally, the pin 102 has caused the projection 114 to pivot upward (via the pivoting arm 112). Hence, the pivoting arm 112 will cause the relay switch (located within the switch housing 116) to cause the light to go off, which in turn informs the operator that the apparatus 2 is now latched. Other types of signals are possible, including sound and electromagnetic radio signals.

In order to unlatch the apparatus 2, the operator may simply activate the latch rotary actuator 14, and in particular the rack, which in turn will cause the roller 96 to rotate thereby contracting the pins 100, 102. Next, the hinge rotary actuator 10 (seen in FIGS. 3 and 4) can be activated in a similar fashion, i.e. the rack moves thereby causing the roller and stem to rotate the hinge pin 8, which would open the apparatus 2.

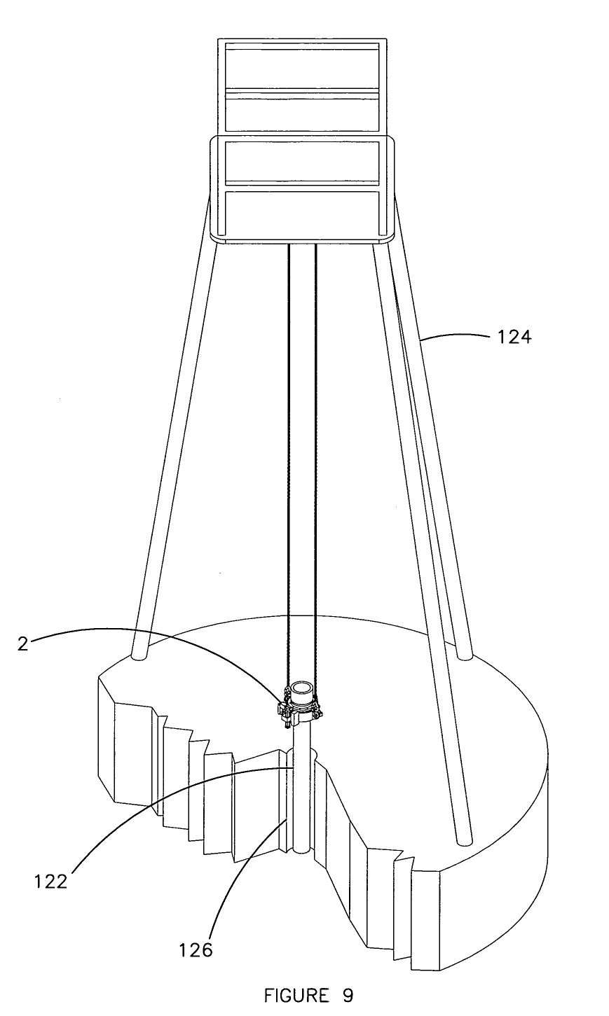

As seen in FIG. 9, when the apparatus 2 is in the latched position, the apparatus 2 can be used to lift, lower, and/or suspend a tubular 122 from a rig 124, with the tubular 122 being suspended within a subterranean well 126.

Although the present invention has been described in terms of specific embodiments, it is anticipated that alterations and modifications thereof will no doubt become apparent to those skilled in the art. It is therefore intended that the following claims be interpreted as covering all such alterations and modifications as fall within the true spirit and scope of the invention.

We claim:

1. An elevator apparatus comprising:
a circular member comprising a first portion and a second portion;
a hinge pin, operatively associated with said first portion and said second portion, for pivoting the first portion relative to said second portion;
a first rotary actuator operatively associated with said first portion and said second portion for actuating rotation of said first and said second portion to pivot about said hinge pin.

2. The apparatus of claim 1 further comprising:
a latch mechanism for latching said first semi-circular half with said second semi-circular half.

3. The apparatus of claim 2 wherein said latch mechanism includes a second rotary actuator for actuating said latch mechanism.

4. The apparatus of claim 3 wherein said first rotary actuator comprises:
a first cylinder;
a first rack disposed within said first cylinder, said rack being responsive to a pressure within said cylinder;
a first roller having teeth disposed thereon, wherein said rack and teeth are
engaged and wherein said roller is connected to said hinge pin.

5. The apparatus of claim 4 wherein said second rotary actuator comprises:
a second cylinder;
a second rack disposed within said second cylinder, said second rack being responsive to a pressure within said second cylinder;
a second roller having teeth disposed thereon, wherein said second rack and teeth are engaged and wherein said second roller is connected to a first so that lateral movement of said second rack causes extension of said first pin.

6. The apparatus of claim 5 further comprising:
indicator means for detecting the extension of said first pin and said second pin.

7. The apparatus of claim 6 wherein said second roller further comprises is connected to a second pin that is offset from said first pin and wherein lateral movement of said second rack causes extension of said second pin in a direction opposite from said first pin.

8. The apparatus of claim 7 wherein said second rotary actuator is operatively associated with a housing, and wherein said first pin has a first position that is recessed within an aperture within said housing and a second position that extends from the housing, and wherein said indicator means comprises a projection that is positioned within said aperture and a relay switch operatively connected to said projection, and wherein upon movement of said first pin from the first position to the second position, said projection is lifted from the aperture which activates said relay switch.

9. An elevator apparatus comprising:
a circular member comprising a first portion and a second portion;
a hinge pin means operatively associated with said first portion and said second portion, for pivoting the first portion relative to said second portion;
a first rotary actuator for rotating said hinge pin means so that said first and second portions pivot to form the circular member;
a latch mechanism for latching said first portion and said second portion together;
a second rotary actuator for actuating the latch mechanism.

10. The apparatus of claim 9 wherein said first rotary actuator comprises:
a first cylinder;
a first rack disposed within said first cylinder, said first rack being responsive to a pressure within said first cylinder;
a first roller having teeth disposed thereon, wherein said first rack and said teeth are engaged and wherein said first roller is connected to said hinge pin means.

11. The apparatus of claim 10 wherein said first cylinder is a pressure cylinder receiving a hydraulic fluid from a hydraulic control unit.

12. The apparatus of claim 11 wherein said second rotary actuator comprises:
a second cylinder;
a second rack disposed within said second cylinder, said second rack being responsive to a pressure within said second cylinder;
a second roller having teeth disposed thereon, wherein said second rack and teeth are engaged and wherein said second roller is connected to a first pin so that lateral movement of said second rack causes said first pin to extend from a recessed position to an extended position.

13. The apparatus of claim 12 further comprising:
indicator means for detecting the extension of said first pin.

14. The apparatus of claim 13 wherein said indicator means comprises a hydraulic switch that is controlled by the position of the first pin.

15. The apparatus of claim 14 wherein said second roller is further connected to a second pin offset from said first pin and wherein lateral movement of said second rack causes extension of said second pin in a direction opposite from said first pin.

16. The apparatus of claim 15 wherein said second rotary actuator is operatively associated with a housing, and wherein said first pin has a first position that is recessed within an aperture within said housing and a second position that extends from the housing, and wherein said indicator means comprises a projection that is positioned within said aperture and a relay switch operatively connected to said projection, and wherein upon movement of said first pin from the first position to the second position, said projection is lifted from the aperture which trips said relay switch.

17. A method of lifting a tubular member on a drilling rig comprising:
suspending an elevator apparatus from the rig, said elevator apparatus comprising: a first portion and a second portion; a hinge pin member(s) operatively associated with said first portion and said second portion, for pivoting the first portion relative to said second portion; a hinge rotary actuator for moving said hinge pin; and, a latch member for latching said first portion and said second portion in order to form a circular member about the tubular;
surrounding the elevator apparatus about the tubular member, said tubular member being suspended in a rotary table on the rig with a slip device or in a more horizontal position from the v-door, pipe rack or catwalk;
activating the hinge rotary actuator so that said first portion and said second portion pivots about the hinge pin;
latching the first portion and the second portion together;
releasing the tubular member from the slip device;
lifting the tubular with the elevator apparatus.

18. The method of claim 17 further comprising:
detecting whether the first portion and the second portion are latched.

19. The method of claim 18 further comprising:
suspending the tubular member within the rotary table on the rig or in a more horizontal position from the v-door, pipe rack or catwalk;
unlatching the first portion from the second portion by activating a latch rotary actuator operatively associated with the latch member so that a first and second pin retract;
activating the hinge pin by activating the hinge rotary actuator;
pivoting the first portion and the second portion in order to separate.

20. The method of claim 17 wherein the hinge rotary actuator comprises: a cylinder; a rack disposed within said cylinder and is responsive to a hydraulic pressure; a roller having teeth thereon, said teeth engaging said rack; and wherein the step of activating the first rotary actuator comprises:
selectively applying pressure in said cylinder;
moving said rack in response to said pressure;
rotating said roller;
pivoting said hinge pin thereby separating the first portion from the second portion.

21. The method of claim 17 wherein the latch rotary actuator comprises: a cylinder; a rack disposed within said cylinder and responsive to pressure; a roller having teeth thereon, said teeth engaging said rack; and wherein the step of activating the hinge rotary actuator comprises:
selectively applying pressure to said cylinder;
moving said rack in response to said pressure;
rotating said roller so that said latching pins contract so that the first portion and the second portion are no longer latched together.
